(19) United States
(12) Patent Application Publication
(10) Pub. No.: US 2017/0114761 A1
(43) Pub. Date: Apr. 27, 2017

(54) RESONATOR ASSEMBLY AND MANUFACTURING PROCESS FOR PRODUCING THE SAME

(71) Applicant: Dura Operating, LLC, Auburn Hills, MI (US)

(72) Inventors: Michael Frank Bauer, Pinconning, MI (US); Joe Rezmer, Pinconning, MI (US)

(73) Assignee: Dura Operating, LLC

(21) Appl. No.: 14/921,148

(22) Filed: Oct. 23, 2015

(51) Int. Cl. F02M 35/12; F02M 35/10

(52) U.S. Cl. CPC F02M 35/1266; F02M 35/10157

(57) ABSTRACT

A resonator assembly includes an outer tube that extends from an inlet to an outlet. The outer tube has at least two chambers formed along a length of the outer tube. An inner tube extends from an inlet to an outlet. The inner tube includes a plurality of perforations formed about the circumference of the inner tube. The inner tube is positioned with the outer tube. The inner and outer tubes frictionally engage upon assembly sealing the at least two chambers relative to each other.

### FIELD OF THE INVENTION

The invention relates to resonator assemblies for use with an internal combustion engine including a turbocharger.

### BACKGROUND OF THE INVENTION

Resonator assemblies may be utilized with internal combustion engines that have turbochargers. Often the operating noises produced by the engine are specified to comply with noise requirements for a desired sound profile. Resonator assemblies may be utilized to dampen or insulate the desired noise emission over various frequency ranges such as between 2,000 and 7,000 hertz.

Prior art resonator assemblies often require complicated manufacturing processes and require joining and welding with numerous subcomponents within an assembly. There is therefore a need in the art for an improved resonator that eliminates numerous connections and is easy to assemble. There is also a need in the art for an improved resonator that is cost effective and dampens desired frequency ranges specified by a car manufacturer. Further, there is a need in the art for an improved resonator that includes bends or curves that are monolithically formed with the resonator to a desired shape eliminating complicated assembly processes with a turbocharger and engine of a vehicle.

### SUMMARY OF THE INVENTION

In one aspect, there is disclosed a resonator assembly that includes an outer tube that extends from an inlet to an outlet. The outer tube includes at least two chambers formed along a length of the tube. The chambers are spaced from each other and separated by a gap. The outer tube includes an inner and outer diameter. An inner tube extends from an inlet to an outlet. The inner tube includes a plurality of perforations formed about the circumference of the inner tube. The inner tube is positioned within the outer tube. The inner diameter of the outer tube includes tapered walls formed thereon. The tapered walls are positioned in the gaps and frictionally seal the inner and outer tubes together.

In another aspect, there is disclosed a resonator assembly that includes an outer tube that extends from an inlet to an outlet. The outer tube has at least two chambers formed along a length of the outer tube. An inner tube extends from an inlet to an outlet. The inner tube includes a plurality of perforations formed about the circumference of the inner tube. The inner tube is positioned within the outer tube. The inner and outer tubes frictionally engage upon assembly sealing the at least two chambers relative to each other.

In yet another aspect there is disclosed a method of forming a resonator assembly that includes the steps of: providing an outer tube having an inlet and outlet, hydroforming a plurality of chambers in the outer tube and hydroforming tapered walls in the outer tube, forming a bend in the outer tube at the inlet of the outer tube, providing an inner tube, forming perforations in the inner tube, forming a bend in the inner tube at the outlet of the inner tube, and inserting the inner tube within the outer tube wherein the inner and outer tubes frictionally engage sealing the at least two chambers relative to each other.

### BRIEF DESCRIPTION OF THE DRAWINGS

FIG. 1 is a perspective view of an inner tube including perforations formed therein;

FIG. 2 is a perspective view of an outer tube including chambers and a bend formed thereon;

FIG. 3 is a partial assembly view of the inner and outer tubes when assembled;

FIG. 3A is a partial enlarged detailed view of FIG. 3;

FIG. 3B is a partial enlarged detailed view of FIG. 3;

FIG. 3C is a partial enlarged detailed view of FIG. 3;

FIG. 3D is a partial enlarged detailed view of FIG. 3;

FIG. 4 is a partial cutaway view detailing the frictional interface of the inner tube and outer tube showing the tapered walls;

FIG. 5 is a plot of the attenuation versus frequency of the resonator including adjustment of attenuation at specified frequency bands;

FIG. 6 is a plot of the attenuation as a function of frequency for one embodiment of a resonator;

FIG. 7 is a partial perspective view of the outer tube including the hydroformed chambers positioned within a die; and

FIG. 8 is a partial perspective view detailing the outer tube positioned within the die and a bend being formed thereon.

### DETAILED DESCRIPTION OF THE PREFERRED EMBODIMENTS

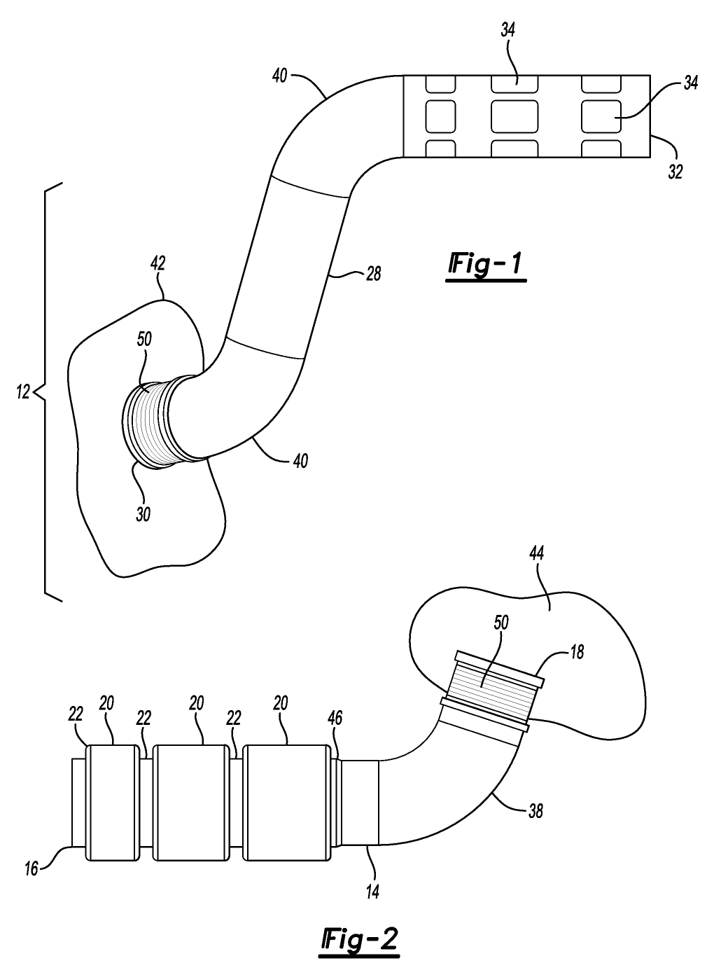

Referring to FIGS. 1-3, there is shown a resonator assembly 12 including an outer tube 14 that extends from an inlet 16 to an outlet 18. The outer tube 14 includes at least two chambers 20 formed along a length of the outer tube 14. The chambers 20 are spaced from each other and separated by a gap 22. The outer tube 14 includes an inner diameter 24 and an outer diameter 26.

An inner tube 28 extends from an inlet 30 to an outlet 32. The inner tube 28 includes a plurality of perforations 34 formed about the circumference of the inner tube 28. The inner tube 28 is positioned within the outer tube 14 when assembled. In one aspect, the inner diameter 24 of the outer tube 14 includes tapered walls 36 formed thereon. The tapered walls 36 are positioned within the gaps 22 when assembled and frictionally seal the inner and outer tubes 28, 14 relative to each other.

Referring to FIG. 1, the outer tube 14 includes a bend 38 monolithically formed thereon proximate the inlet 16 of the outer tube 14. Additionally, the inner tube 28 includes a bend 40 monolithically formed thereon proximate the outlet 32 of the inner tube 28. When assembled, the inner tube 28 extends from a turbocharger 42 to the outer tube 14 which is coupled with a cooler 44. In one aspect, hot air from the turbocharger is routed to the cooler and back through a cold side to a throttle body.

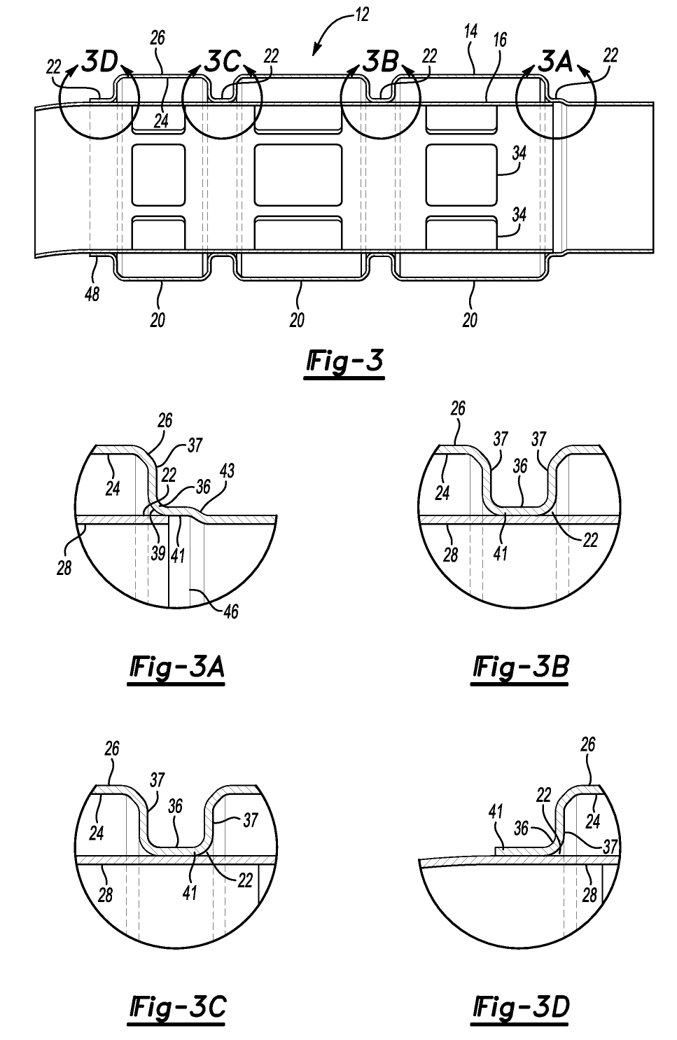

In one aspect, the perforations 34 formed within the inner tube 28 are positioned within the chambers 20 of the outer tube 14 when assembled. The outer tube 14 may include a stop 46 formed thereon that defines a position of the inner tube 28 when inserted within the outer tube 14. Referring to FIG. 3A the stop may include a reduced diameter section that engages the outlet of the inner tube 28. In this manner, the perforations 34 will be positioned a predetermined distance within the chambers 20. In one aspect, the perforations 34 may be rectangular shaped slots that are punched into the circumference of the inner tube 28. It should be realized that various shapes may be utilized other than the rectangular slots depicted in the figures.

Referring to FIG. 2, the outer tube 14 includes at least two chambers 20 formed along a length of the outer tube 14. In the depicted embodiments, the outer tube 14 includes three chambers 20 formed along a length of the outer tube 14. Various numbers of chambers 20 may be utilized to attenuate at specified frequencies. In one aspect, the outer tube 14 may be hydroformed to define the chambers 20 within the outer tube 14.

In one aspect, a position of the perforations 34 formed along the length of the inner tube 28 may be adjusted such that a specified distance is provided positioning the slots at a desired location within the chambers to attenuate at a desired frequency. Referring to FIG. 5, there is shown two plots with the perforations 34 positioned in alternate positions within the chambers 20.

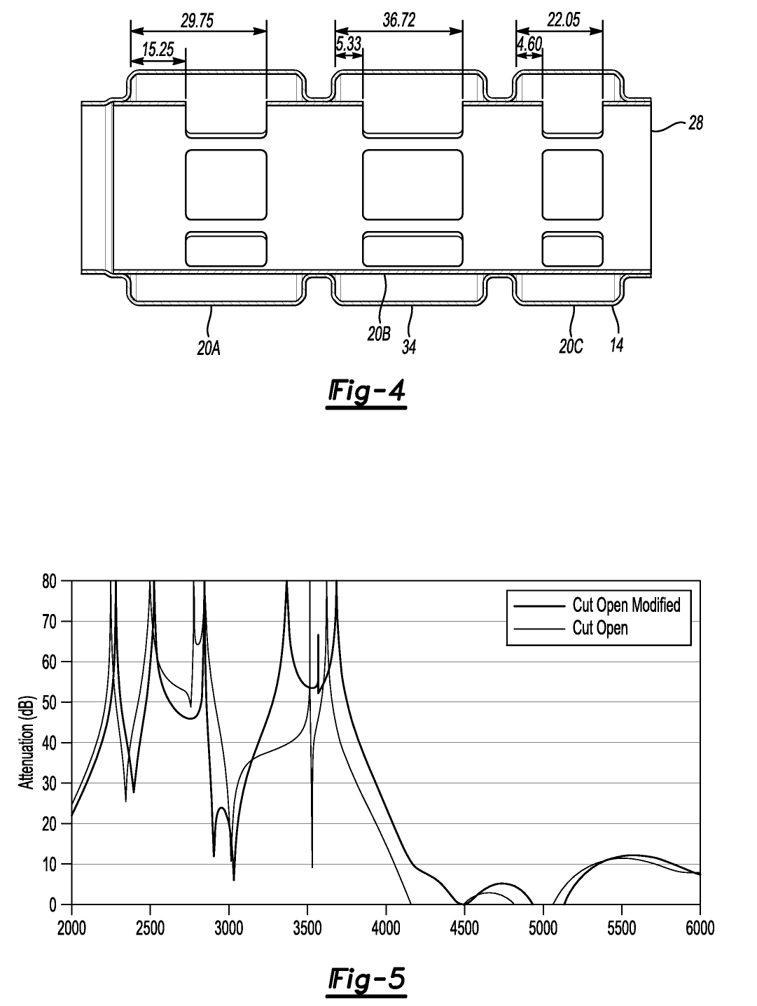

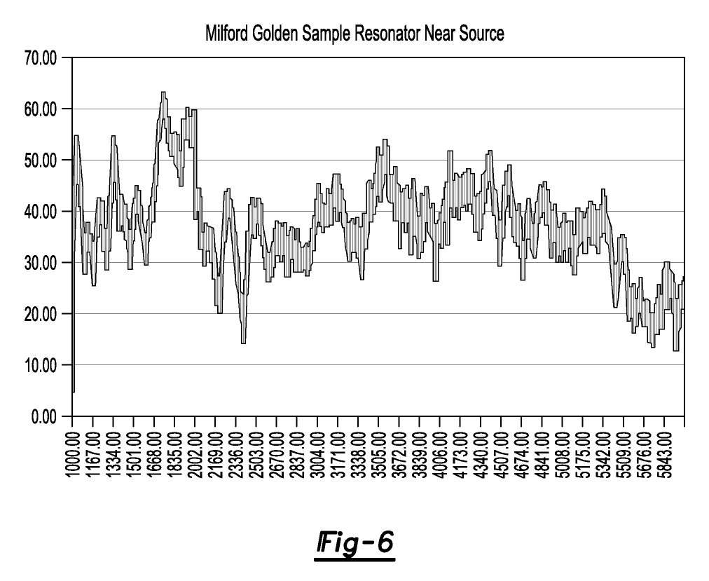

In the first plot, the perforations 34 are positioned to measure a distance as specified in FIG. 4. Datum lines are provided in the figure identifying the edges 21 of the chambers 20. The perforations 34 within the first chamber 20A begins at 15.25 mm as measured from a left most edge 21 of the chamber 20A and extends to 29.75 mm as measured from the left most edge 21 of the chamber 20A, whereas the perforations 34 in the second chamber 20B begins at 5.3 mm as measured from a left most edge 21 of the chamber 20B and extends to 36.72 mm as measured from the left most edge 21 of the chamber 20B, whereas the perforations 34 in the third chamber 20C begins at 4.6 mm as measured from a left most edge 21 of the chamber 20C and extends to 22.5 mm as measured from the leftmost edge 21 of the chamber 20C. In the depicted embodiment of FIG. 4 the measurements are from left to right as shown in the figure.

In the second plot, the perforations 34 are measured as described above with respect to the first plot. The perforations in the first chamber 20A are positioned from 14.9 mm to 30.06 mm and the perforations 34 in the second chamber 20B are positioned at 4.2 mm to 45.3 mm, whereas the perforations 34 in the third chamber 20C are positioned at 4.95 mm to 21.7 mm.

As can be seen in the plots of FIG. 5, the position of the perforations 34 within the chambers 20 may be adjusted to provide a desired attenuation at various frequencies. Specifically as shown in the plot of FIG. 5, the movement of the perforations in the second plot results in a higher attenuation at 3500 Hz.

Referring to FIG. 3, there is shown an assembly view of the resonator assembly 12 including the inner tube 28 positioned within the outer tube 14 such that the inner and outer tubes 28, 14 frictionally engage upon assembly sealing the chambers 20 relative to each other. As seen in FIG. 3, the outer tube 14 includes tapered walls 36 formed thereon. The tapered walls 36 are positioned in the gaps 22 and frictionally seal the inner and outer tubes 28, 14. In this manner, when assembling the resonator assembly 12 complicated welds positioned between the inner and outer tubes 28, 14 are negated and frictional engagement of the inner and outer tubes 28, 14 provides a sealing between adjacent chambers 20. In one aspect, the resonator assembly 12 includes a single weld 48 joining the inner and outer tubes 28, 14 at the outlets of the inner and outer tubes 28, 14. In this manner, the assembly of the resonator assembly 12 for installation is efficient requiring only a single weld.

The tapered wall 36 of FIG. 3A includes a downward extending portion 37 that transitions at a radius 39 to a contact portion 41 that frictionally engages the inner tube 28. The tapered wall 36 further extends to an angled portion 43 that accommodates the stop 46.

The tapered wall 36 of FIGS. 3B and 3C includes a pair of downward extending portions 37 that transitions at a radius 39 to a contact portion 41 that frictionally engages the inner tube 28.

The tapered wall 36 of FIG. 3D includes a downward extending portion 37 that transitions at a radius 39 to a contact portion 41 that frictionally engages the inner tube 28. The inner tube 28 further continues to a bend 40 and connects with the turbocharger 42.

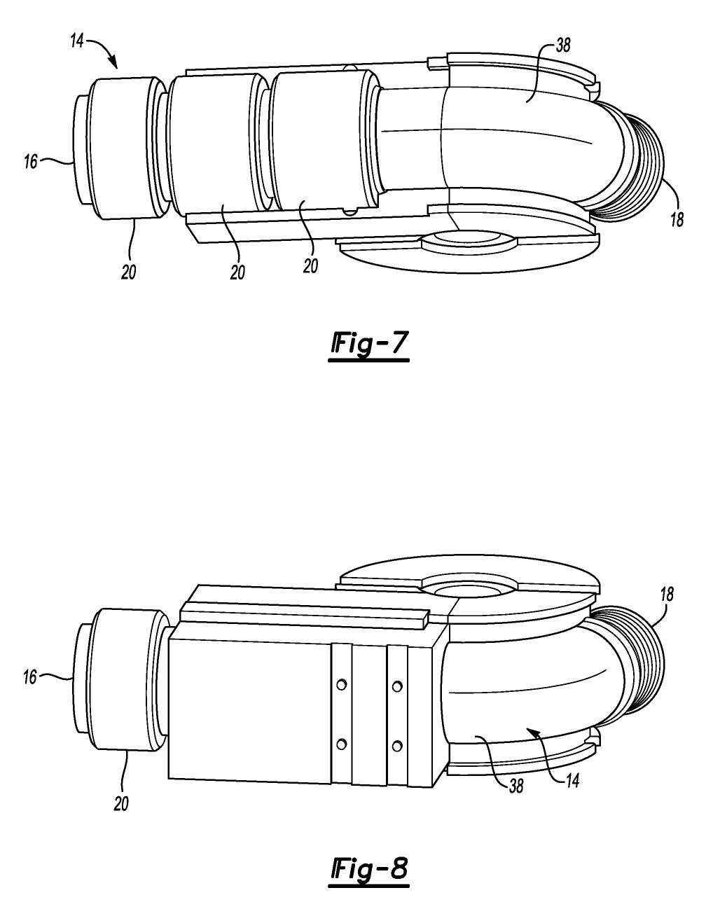

Referring to FIGS. 7-8, there is depicted pictorial views of a method of forming a resonator assembly 12. The method includes providing an outer tube 14 having an inlet 16 and outlet 18. Hydroforming at least two chambers 20 in the outer tube 14 and hydroforming the tapered walls 36 in the outer tube 14. Following formation of the chambers 20 a bend 38 is formed in the outer tube 14, as shown in FIG. 2. An inner tube 28 is provided and perforations 34 are formed in the inner tube along the circumference of the inner tube 28. A bend 40 is formed in the inner tube 28. The inner tube 28 is inserted within the outer tube 14 such that the inner and outer tubes 28, 14 frictionally engage each other at the tapered walls 36 sealing the at least two chambers 20 relative to each other, as shown in FIG. 3.

In one aspect, when the inner tube 28 and outer tube 14 are frictionally joined, there is the step of a single weld joint 48 being formed joining the inner and outer tubes 28, 14. The single weld joint 48 provides a simple procedure to create the resonator assembly 12 as opposed to prior art resonators that require multiple welds joining various components.

In one aspect, the step of forming perforations 34 in the inner tube 28 includes punching perforations 34 in the inner tube 28 at specified positions about the circumference and along the length of the inner tube 28. In one aspect, the bend 40 of the inner tube may be formed thereon prior to punching the perforations 34.

Further, the step of forming a bend 38 in the outer tube includes positioning the hydroformed outer tube 14 in a die and bending the outer tube 14 to a predefined curve as shown in FIGS. 7-8. Coupling joints 50 may be formed on the inner and outer tubes 28, 14 to allow assembly with the turbocharger 42 and cooling sections 44.

We claim:

1. A resonator assembly comprising:
an outer tube extending from an inlet to an outlet, the outer tube having at least two chambers formed along a length of the tube, the chambers spaced from each other and separated by a gap, the outer tube including an inner and outer diameter;
an inner tube extending from an inlet to an outlet, the inner tube including a plurality of perforations formed about the circumference of the inner tube, the inner tube positioned within the outer tube; and
wherein the inner diameter of the outer tube includes tapered walls formed thereon, the tapered walls positioned in the gaps and frictionally sealing the inner and outer tubes.

2. The resonator assembly of claim 1 wherein the outer tube includes a bend monolithically formed thereon proximate the inlet of the outer tube.

3. The resonator assembly of claim 1 wherein the inner tube includes a bend monolithically formed thereon proximate the outlet of the inner tube.

4. The resonator assembly of claim 1 wherein the perforations are positioned within the chambers of the outer tube.

5. The resonator assembly of claim 1 wherein the outer tube includes a stop formed thereon defining a position of the inner tube within the outer tube when assembled.

6. The resonator assembly of claim 1 wherein the perforations are rectangular shaped slots.

7. The resonator assembly of claim 1 including a single weld joining the inner and outer tubes at the outlets of the inner and outer tubes.

8. The resonator assembly of claim 1 wherein the outer tube includes three chambers formed along a length of the outer tube.

9. The resonator assembly of claim 1 wherein a position of the slots along the length of the inner tube is adjusted to a specified distance positioning the slots at a specified position within the chambers to attenuate at a desired frequency.

10. A resonator assembly comprising:
an outer tube extending from an inlet to an outlet, the outer tube having at least two chambers formed along a length of the tube;
an inner tube extending from an inlet to an outlet, the inner tube including a plurality of perforations formed about the circumference of the inner tube, the inner tube positioned within the outer tube; and
wherein the inner and outer tubes frictionally engage upon assembly sealing the at least two chambers relative to each other.

11. The resonator assembly of claim 10 wherein the outer tube includes a bend monolithically formed thereon proximate the inlet of the outer tube.

12. The resonator assembly of claim 10 wherein the inner tube includes a bend monolithically formed thereon proximate the outlet of the inner tube.

13. The resonator assembly of claim 10 including a single weld joining the inner and outer tubes at the outlets of the inner and outer tubes.

14. The resonator assembly of claim 10 wherein the outer tube includes a stop formed thereon defining a position of the inner tube within the outer tube when assembled.

15. The resonator assembly of claim 10 wherein a position of the slots along the length of the inner tube is adjusted to a specified distance positioning the slots at a specified position within the chambers to attenuate at a desired frequency.

16. A method of forming a resonator assembly comprising the steps of:
providing an outer tube having an inlet and outlet;
hydroforming a plurality of chambers in the outer tube and hydroforming tapered walls in the outer tube;
forming a bend in the outer tube at the inlet of the outer tube;
providing an inner tube;
forming perforations in the inner tube;
forming a bend in the inner tube at the outlet of the inner tube;
inserting the inner tube within the outer tube wherein the inner and outer tubes frictionally engage sealing the at least two chambers relative to each other.

17. The method of forming a resonator assembly of claim 16 including the step of welding a single joint joining the inner and outer tubes at the outlets of the inner and outer tubes.

18. The method of forming a resonator assembly of claim 16 wherein the step of forming perforations includes punching perforations in the inner tube.

19. The method of forming a resonator assembly of claim 16 wherein the step of forming a bend in the outer tube at the inlet of the outer tube includes positioning the hydroformed outer tube in a die and bending the outer tube to a predefined curve.

20. The method of forming a resonator assembly of claim 16 including the step of forming coupling joints on the inner and outer tubes.

21. A resonator assembly comprising:
an outer tube extending from an inlet to an outlet, the outer tube having at least two chambers formed along a length of the tube, the chambers spaced from each other and separated by a gap, the outer tube including an inner and outer diameter;
an inner tube extending from an inlet to an outlet, the inner tube including a plurality of perforations formed about the circumference of the inner tube, the inner tube positioned within the outer tube; and
wherein the inner diameter of the outer tube includes tapered walls formed thereon, the tapered walls including a downward extending portion that transitions at a radius to a contact portion that frictionally engages the inner tube, the tapered walls positioned in the gaps and frictionally sealing the inner and outer tubes.
